(19) United States
(12) Patent Application Publication
(10) Pub. No.: US 2011/0226165 A1
(43) Pub. Date: Sep. 22, 2011

(54) Convertible Table and Method of Use

(76) Inventor: Scott Ballard, Houston, TX (US)

(21) Appl. No.: 12/727,093

(22) Filed: Mar. 18, 2010

(51) Int. Cl. A47B 13/02; A47B 13/08; B23P 19/00

(52) U.S. Cl. 108/12; 108/11; 29/426.1

(57) ABSTRACT

A system and method for a table that is convertible between a first configuration and a second configuration. The convertible table generally includes a base and a top comprising a plurality of panels. The panels interact to form the top of the table in both configurations. In the first configuration, the panels are combined to produce a lesser surface area than the panel configuration once expanded. This may be accomplished by any number of combination techniques such as by variations of stacking, staggered, or in any other manner that generally provides for a top with less surface area than the top of the second configuration. In the second configuration, at least two of the panels may be positioned adjacent to each other to form a substantially uniform surface. The surface area of the expanded top is generally larger than the surface area of the top in the first configuration.

### STATEMENT REGARDING FEDERALLY SPONSORED RESEARCH OR DEVELOPMENT

Not Applicable.

### FIELD OF THE DISCLOSURE

The disclosure relates generally to convertible tables and, more particularly, to a convertible table that converts between a first configuration and a second configuration.

### BACKGROUND

Standard sized, and other varying sized, gaming tables can be found in many homes and business. These tables generally require a great deal of storage space and may be difficult or cumbersome to assemble and move. As the prevalence of gaming tables in homes and businesses has increased, variations of the structures and uses of similar tables have expanded. While some of the available tables are regulation sized for various games such as ping pong, other sizes vary greatly.

### BRIEF SUMMARY OF THE DISCLOSURE

A convertible table is provided that converts between a first configuration and a second configuration. It should be noted that the use of the words “first” and “second” in this context does not indicate any particular order or desired order but is merely employed to denote two separate configurations. The convertible table generally includes a base and a top comprising a plurality of panels. The panels interact to form the top of the table in both configurations. In the first configuration, the panels are combined to produce a lesser surface area than the panel configuration once expanded. This may be accomplished by any number of combination techniques such as by variations of stacking, staggered, or in any other manner that generally provides for a top with less surface area than the top of the second configuration. In the second configuration, at least two of the panels may be positioned adjacent to each other to form a substantially uniform surface. The surface area of the top in the second configuration is generally larger than the surface area of the top in the first configuration.

The base may comprise a plurality of base members configured to form a single base unit in the first configuration and at least two base members in the second configuration. At least two base members are functionally coupled to provide a sturdy base of support for the top of the second configuration.

Support members may be utilized in conjunction with the base in order to provide additional support to the top of the second configuration. The support members may be spaced along the base coupling as needed for proper support of the top.

The second configuration may comprise a standard sized table tennis or ping pong table. Including the height of the table, the length and width of the table, and the requisite markings for the top.

In an exemplary embodiment, four panels are provided, each representing one fourth of a standard sized ping pong table. Alternatively six panels may be provided, each representing one sixth a standard sized ping pong table and so forth. Alternatively, the dimensions of the top of the second configuration may be less than the width and/or length of a standard sized ping pong table. Alternatively, the dimensions of the top of the second configuration may be greater than the width and/or length of a standard sized ping pong table.

The panels may be combined to produce a smaller surface area over the top than that of the expanded panel orientation of the second configuration. A trim may be attached to the perimeter of the panels. The trim may be comprised of at least some of the support panels that are utilized to, in part, construct the support base. Alternatively, the trim will comprise all of the support panels that are used to, in part, construct the support base.

The base, in the first configuration, may include storage space. Any number of different items may be stored within the base, such as a brace for the support base, nets, paddles, balls, books, DVD's, games, etc.

An aspect of the invention provides for a convertible table that is convertible between a first configuration and a second configuration, the convertible table including: a top having panels, wherein the panels are configured in the first configuration to be stacked, wherein the panels in the second configuration are configured to be positioned adjacent and substantially planar to one another, and wherein the top has a greater surface area in the second configuration than in the first configuration; a base comprising two members configured to support the top, and wherein the base comprises a greater height in the second configuration than in the first configuration; and support members configured to couple to the top as borders of the top in the first configuration, and wherein the members are configured to couple to the base as cross members supporting the top in the second configuration.

Another aspect of the invention provides for a convertible table that is convertible between a larger configuration and a smaller configuration, the convertible table including: four panels configured to be disposed side-by-side in the larger configuration and to be stacked in the smaller configuration, wherein the four panels form a top having a larger surface area in the larger configuration than in the smaller configuration; two base portions configured to be disposed substantially vertically in the larger configuration and disposed substantially horizontally in the smaller configuration, wherein the two base portions form a base having a greater height in the larger configuration than in the smaller configuration, and wherein the top sits atop the base in both the larger and smaller configurations; a brace configured to couple the two base portions in the larger configuration; and four elongated members configured to be disposed as end members around the top in the smaller configuration and as cross pieces under the top in the larger configuration.

Yet another aspect of the invention provides for a method of reassembling a convertible table from a first configuration to a second configuration, the method including: accessing the convertible table in a first configuration, wherein the convertible table in both the first configuration and the second configuration has a top and a base, the top including a plurality of panels and the base including a plurality of base portions; disassembling the first configuration, wherein disassembling includes: decoupling and removing a plurality of borders from around the top, wherein the panels of the top are stacked in the first configuration; removing the panels from the base of the first configuration, wherein at least two base portions are arranged in a substantially horizontal orientation in the first configuration. Further, assembling the second configuration, wherein assembling includes: reorienting at least two base portions of the base from the substantially horizontal orientation to a substantially vertical orientation to form the base for the second configuration; coupling the two base portions, wherein this coupling may be accomplished with a brace; installing borders of the first configuration as cross members on the base in the second configuration; and positioning the panels side-by-side as a top on the base to form a top having a larger surface area than the first configuration.

Yet another aspect of the invention provides for a method including: providing a top of a convertible table, the top comprising a plurality of panels (e.g., four panels), wherein the panels are stacked in a first configuration, wherein the four panels are positioned with each of two panels situated side-by-side and each of the panel sets situated end to end forming a rectangular configuration. All panels being substantially planar in a second configuration, and wherein the top has a greater surface area in the second configuration than in the first configuration; providing a base of the convertible table, the base having at least two base portions configured to support the top, and wherein the base has a greater height in the second configuration than in the first configuration; providing a brace configured to couple at least two base portions in the second configuration and to support the top in the second configuration; and providing elongated members configured as edge members, or trim, to be disposed around the top in the first configuration, and configured as support members to support the top in the second configuration.

Other features will be apparent from the following detailed description, the accompanying drawings, and the appended claims.

### BRIEF DESCRIPTION OF THE DRAWINGS

The invention and its advantages are best understood by referring to the drawings, like numerals being used for like and corresponding parts of the various drawings.

FIG. 1 is a perspective view of a convertible table in a second configuration.

FIG. 2 is a perspective view of a convertible table in a second configuration.

FIG. 3 is a perspective view of the convertible table in a substantially disassembled state.

FIG. 4 is a perspective view of an intermediate stage of the construction of the support base.

FIG. 5 is a perspective view of the support base as fully constructed.

FIG. 6 is a perspective view of a clamp, which may be utilized as a connection member.

FIG. 7 is a perspective view of an exemplary embodiment of a brace.

FIG. 8 is a cross-section of a partial view of the convertible table depicting the spline and panel grooves if adjacent panels.

FIG. 9 is a cross-section of an end of the convertible table in the second configuration, showing the interaction of a connection member with a base member and support member, and the positioning of a panel in relation thereto.

FIG. 10 is a perspective view of a portion of the support base.

FIG. 11 is a perspective view of the convertible table with the first two panels being installed thereon.

FIG. 12 is a perspective view of the table of FIG. 11 as a third panel is installed thereon.

FIG. 13 is a perspective view of the table of FIG. 12 as a fourth panel is installed thereon.

FIG. 14 is a perspective view of the convertible table as it is being converted to the first configuration.

FIG. 15 is a perspective view of the table of FIG. 14 with the panels in a stacked configuration.

FIG. 16 is a perspective view of the table of FIG. 15 in the first configuration.

FIG. 17 is a cross-sectional view of the table of FIG. 16.

FIG. 17A is a close-up cross-sectional view of the section marked 17A in FIG. 17.

FIG. 18 is a cross-sectional top view of the convertible table of FIG. 16.

### DESCRIPTION OF EXAMPLE EMBODIMENTS

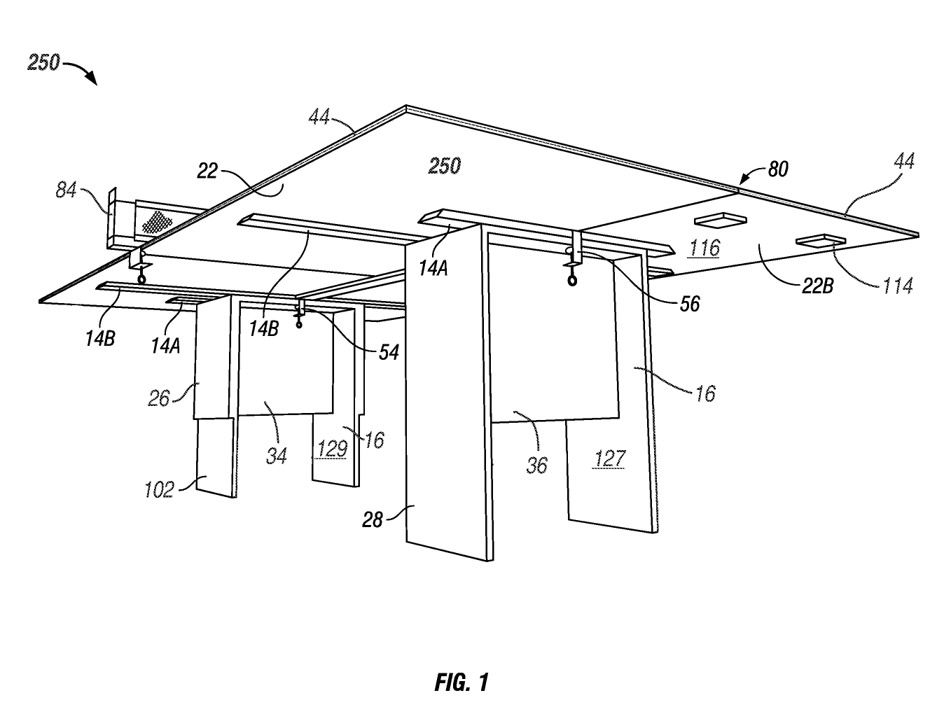

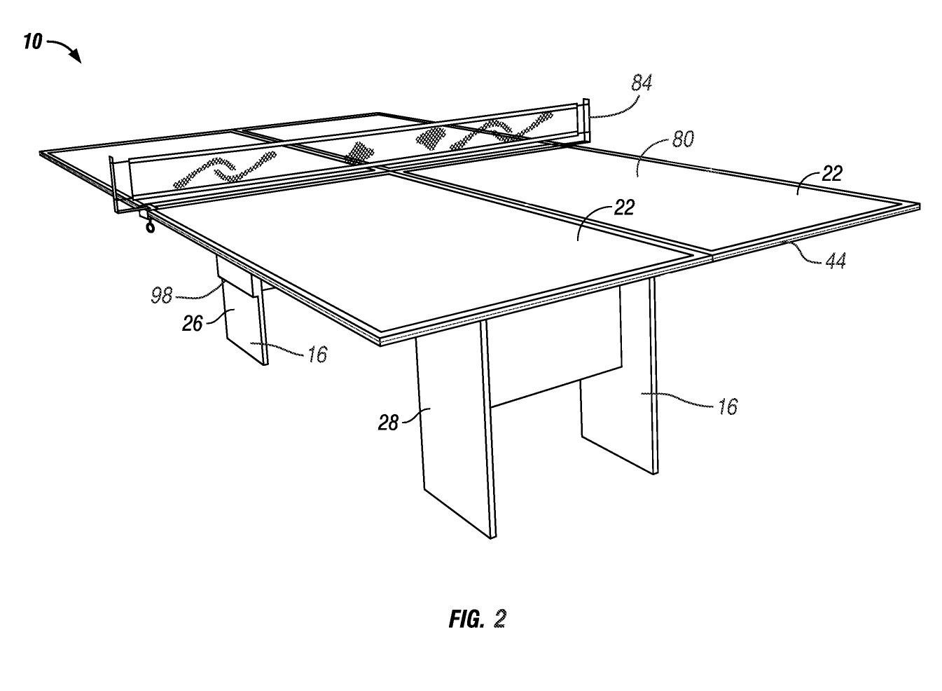

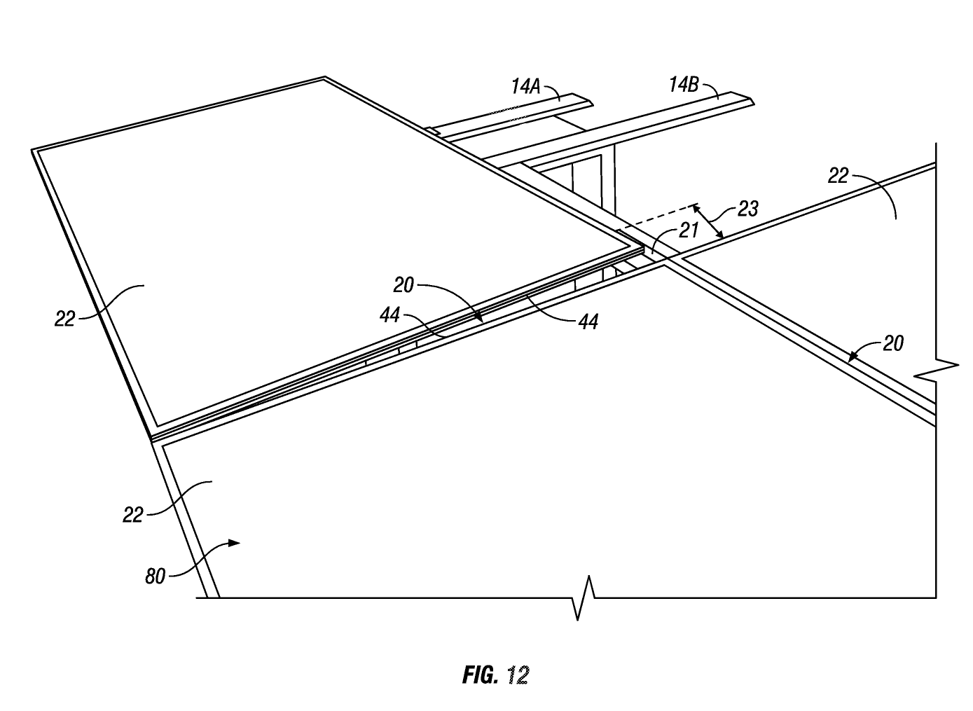

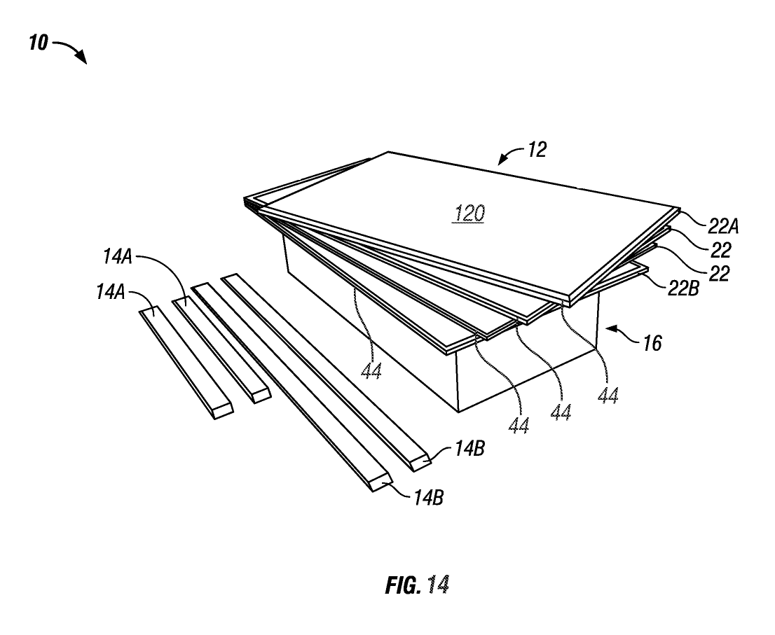

Referring to FIGS. 1-3, a convertible table 10 that is convertible between a first configuration 200 and a second configuration 250 generally comprises a base 16, a plurality of panel members 22, and a plurality of support members 14. Again, the use of the words “first” and “second” in this context does not indicate any particular order or desired order but is merely employed to denote two separate configurations. The second configuration 250 of an exemplary convertible table 10 is shown in FIGS. 1 and 2. The second configuration 250 of the convertible table has a generally larger surface area than the first configuration 200. Various stages of the assembly of the second configuration 250 and the first configuration 200 are shown in FIGS. 1-5 and 11-16.

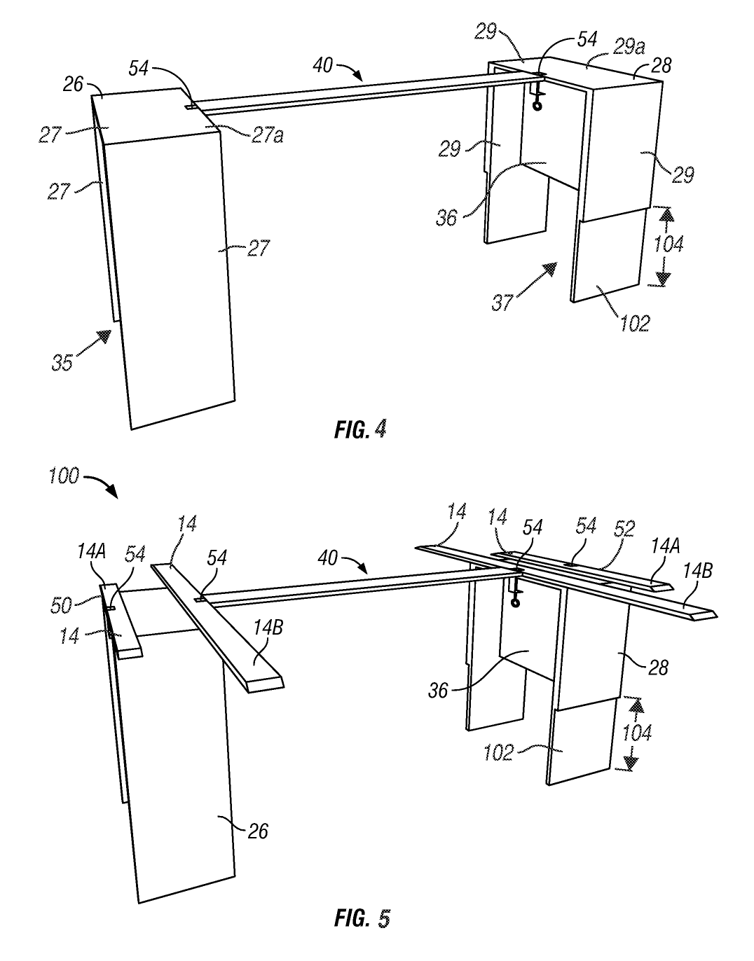

Referring to FIG. 4, the base is comprised of two base members 26 and 28. Base members 26 and 28 have at least two wall segments 27 and 29, respectively. The exemplary embodiment shown includes three wall segments 27 and three wall segments 29. The segments 27 are operationally connected wherein one horizontally configured segment 27a is disposed intermediate the two remaining vertically configured wall segments 27. Similarly, the segments 29 are operationally connected wherein one horizontally configured segment 29a is disposed intermediate the two remaining vertically configured wall segments 29. The vertically configured wall segments 27 and 29, may be longer in relation to the length of the horizontally configured wall segments 27a and 29a.

An inner member 36 is disposed within at least a portion of the cavity 37 that is defined by the wall segments 29. Similarly, an inner member 34 is disposed within at least a portion of the cavity 35 that is defined by the wall segments 27. In the exemplary embodiment shown, the inner members 34 and 36 (see FIG. 1) are connected on three sides to their respective three walls 27 and 29. The inner members 34 and 36 do not extend the full length of the vertically configured walls 27 and 29. The inner members 34 and 36 do not encompass the full width of their respective walls 27 and 29.

A purpose of the inner members 34 and 36 is to support the respective base members 26 and 28 and to strengthen the interaction of the walls 27 and 29. The inner members 34 and 36 aid to support the weight of the top 80 once installed upon the base 16. The inner members 34 and 36 may be configured in an alternative manner to that shown in the exemplary embodiment, yet retain the function that they serve herein. By way of example, the inner embers 34 and 36 may be attached to two of the three walls 27 and 29; they may extend the full length of the base members 26 and 28; they may be formed of diagonal crossbars, and so forth. Further, the inner members 34 and 36 may function as shelving for the base 16 when the convertible table 10 is in the first configuration.

A brace 40 extends between the base members 26 and 28, operationally coupling the two. Referring to FIG. 7, the base is generally comprised of at least one brace member 74 and a plurality of connection members 54. The brace member 74 is a generally elongated member. In the exemplary embodiment shown, the brace member 74 is longer in relation to the length of the wall segments 27 and 29. A purpose of the brace 40 is to functionally couple the base members 26 and 28 together in order to support a top 80 (see FIGS. 1 and 2) thereon. A further function of the brace may be to provide spacing and/or balancing in relation to the base members 26 and 28. Therefore, the length and width of the brace member 74, and the number of brace members 74 utilized, may be varied as desired.

The brace member 74 is flanked by a plurality of connection members 54 in the exemplary embodiment shown. A purpose of the connection members 54 is to operationally connect the base members 26 and 28 to the brace 40. This connection secures the base of the second configuration 250 in order to support a top 80 contained thereon and subsequent reasonable use of that top 80. The connection members 54 are functionally coupled to the brace member 74 by fasteners 76. The connection members 54 are positioned in relation to the brace member 74 such that operational attachment may be facilitated between the brace member 74 and the base 16.

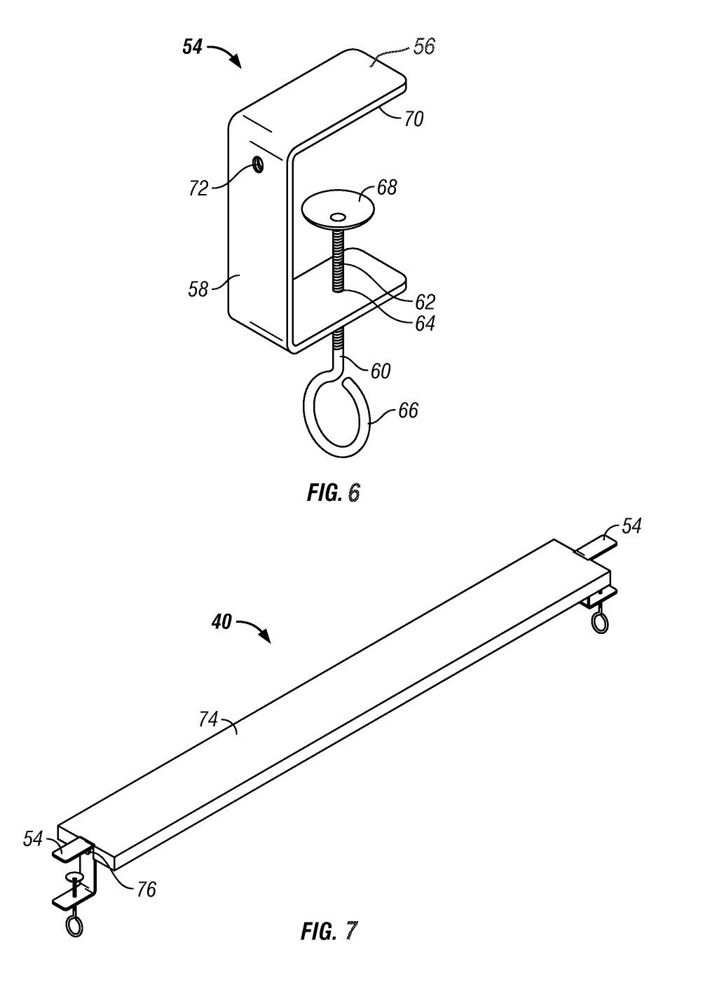

The connection member 54 may be any known or later discovered connector. Referring to FIG. 6, an exemplary connection member 54 is shown, namely, a clamp 56 having a C-portion 58 and a stem 60. The stem 60 has threads 62, which mate with internal threads 64 of the C-portion 56. The stem 60 also has an extension or handle 66 for turning the stem 60. Further, the stem 60 has a surface 68 to interface with the objects to be secured. In operation, the clamp 54 is place around the object or objects to be secured. The handle 66 is turned until the object is sufficiently secured between the surface 68 of the stem 66 and the inner surface 70 of the C-portion 58. Lastly, the clamp 54 has a hole 72 so that the clamp 54 may be fastened via a fastener 76, such as a nail or screw or other known or later discovered fasteners 76, to an object. In this example, the clamp 54 can be part of the brace 40 by being screwed or nailed via hole 72 to an end of the brace 40 (see FIG. 7), for instance. It should be noted that the C-clamp 54 is only given as an example and not meant to limit the present techniques.

Referring to FIG. 5, a plurality of support members 14 are positioned on the surface of the horizontally configured wall segments 27a and 29a. The support members 14 are functionally coupled to the base members 26 and 28 by connection members 54. In an alternative embodiment, at least one of the support members 14 may be coupled to the brace 40.

The exemplary embodiment shown comprises two internal support members 14B and two external support members 14A. The internal support members 14B are longer in relation to the external support members 14A. This length disparity is primarily due to the use of the support members 14 as lateral supports in the first configuration 200 as will be described in more detail below.

The support members 14 are disposed transverse in relation to the brace 40. The external support members 14A are positioned distal the brace 40 at the respective external ends 50 and 52 of the base members 26 and 28. The internal support members 14B are positioned proximate the brace member 40 and intermediate the external support members 14A.

A purpose of the support members 14 is to receive, and provide lateral support for, the top 80. The support members 14 may act as cross-members in this regard. The length, size, and/or number of support members 14 may vary as necessary or desired in order to satisfactorily support the top 80.

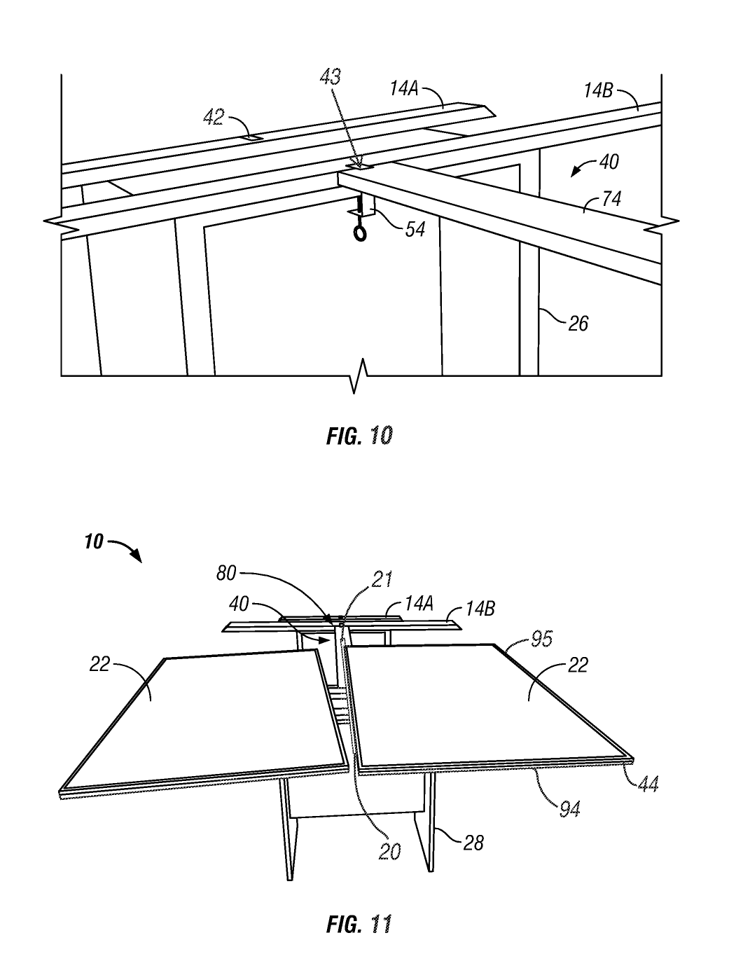

Referring to FIGS. 9 and 10, in the exemplary embodiment shown the support members 14 have an indention 48 at the location where the support member 14 will be connected to the convertible table 10 by the connection members 54. The upper segment 42 of the connection member 54 fits within the indention 48 such that the top surface 43 of the upper segment 42 lies substantially flush with the inner surface 15 of the support members 14. A purpose of the positioning of the upper segment 42 within the indention 48 is to allow for a substantially even support surface across the various support members 14 for the top 80.

The base members 26 and 28 are functionally connected to each other and to at least one support member 14 and/or brace 40 via at least one connection member 54 in order to form the support base 100 for the top 80.

Referring to FIG. 11, a plurality of panels 22 are provided in order to form the top 80. Two panels are shown as they are being installed on the support base 100. The panels 22 are generally planar members with two opposed lateral ends 94 and opposed longitudinally extending ends 95. The opposed longitudinally extending ends 95 of the exemplary embodiment being of a greater length than the opposed lateral ends 94. It is understood that the panels 22 may take any number of configurations to suit the purpose of the expanded top 80.

The panels 22 are operationally coupled along at least a portion of their respective sides 95 and/or 94. The panels are contained together to form the top 80. This operational coupling may be achieved by any known or later discovered means.

The exemplary embodiment utilizes a plurality of splines 20 to effect the necessary couplings. Each panel 22 has a slot 44 extending at least partially around the periphery of each panel 22. More specifically, each panel 22 has at least a portion of a slot 44 extending along the periphery of each side 95 and 94 of each panel 22. The slot 44 may be disposed along the edge of the panels 22. At least a portion of each slot 44 accepts at least a portion of a spline 20. The splines 20 affect the functional couplings of the panels 22. The splines 20 are shaped and sized for snug insertion into slot 44 in order to effect a connection between corresponding slots 44.

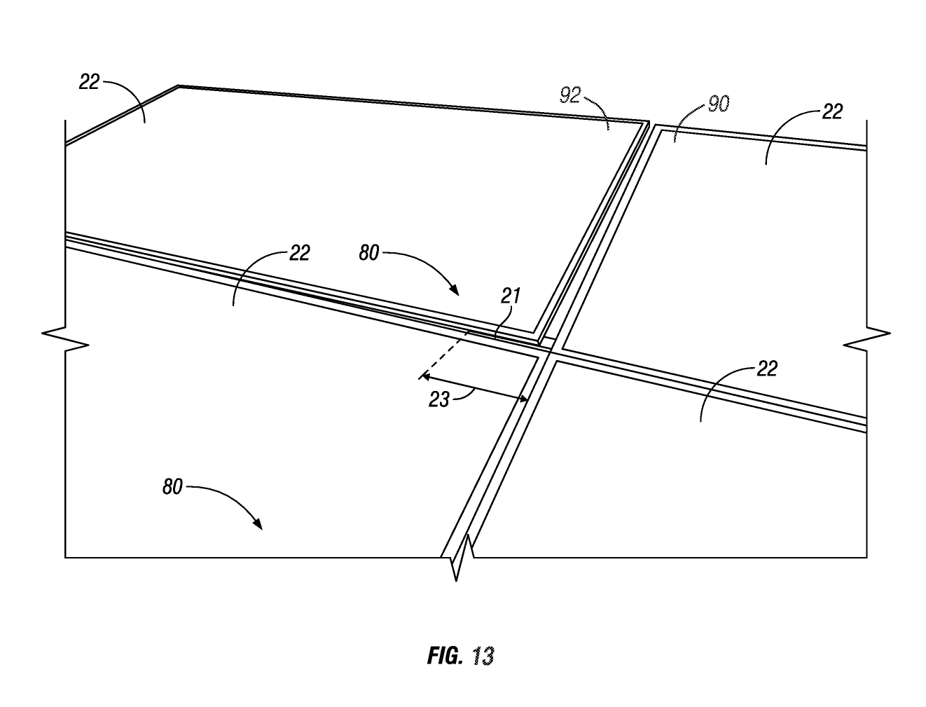

Referring to FIGS. 11-13, at least one spline 20 is positioned such that at least a portion of the length 23 of an end of the spline 21 extends beyond the length of at least one panel 22. This extension 21 allows for the connection of each of at least three panels 22; four panels are shown connected in FIG. 13. The exemplary embodiment depicted allows for coupling of up to four panels 22 through a single extension 21 to form top 80. This connection allows one spline portion 21 to simultaneously couple all four panels 22, giving the top 80 additional support between the two halves 90 and 92. In the depicted embodiment, two adjacent panels 22, adjacent along at least one of each of their respective longitudinally extending ends 95, defines a half 90 or 92.

The spline 20 with the extending spline portion 21 may be the same length as the remaining splines 20 or may be of a different length. The remaining splines 20 may be of equal, non-equal length, or a combination of both equal and non-equal lengths. A purpose of the splines 20 is to functionally couple at least two panels 22. A purpose of the spline extension 21 is to couple at least three panels 22.

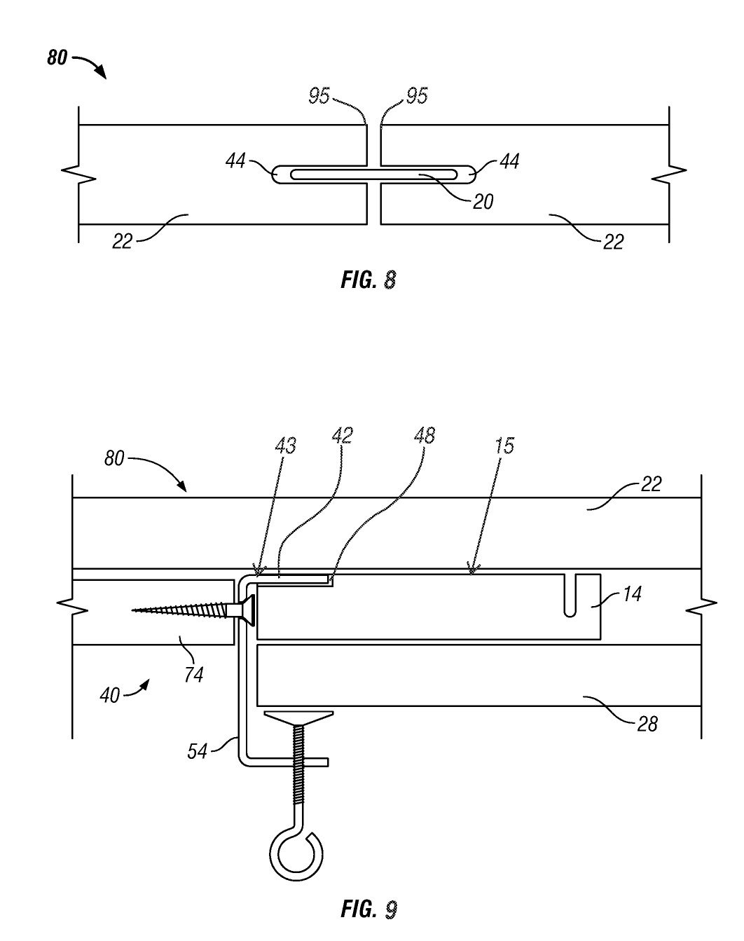

Referring to FIG. 8, the splines 20 are at least partially inserted into a slot 44 along an edge 94 or 95. The free end of the spline 20 is then positioned such that it will at least partially extend into the slot 44 of an adjacently placed panel 22. The top 80 is formed through the appropriate placement of the panels 22 on the support base 100. More or less panels 22 may be utilized in varying shapes and/or sizes as desired. More or less splines 20 may be utilized as needed to form connections between at least some of the various panels 22. The panels 22 may be connected via alternative means such as hinges, at least one integrally formed spline 20 contained on at least one panel 22, hook and loop fasteners, or any other reasonable manner.

Returning to FIGS. 11-13, the weight of the panels 22, together with their coupling along adjacent sides 94 and 95, retain the top 80 on to the support base 100. The coupling through the extension 21 may aid in this stability. If desired, connectors may be employed in order to further support the functional coupling of the top 80 to the support base 100.

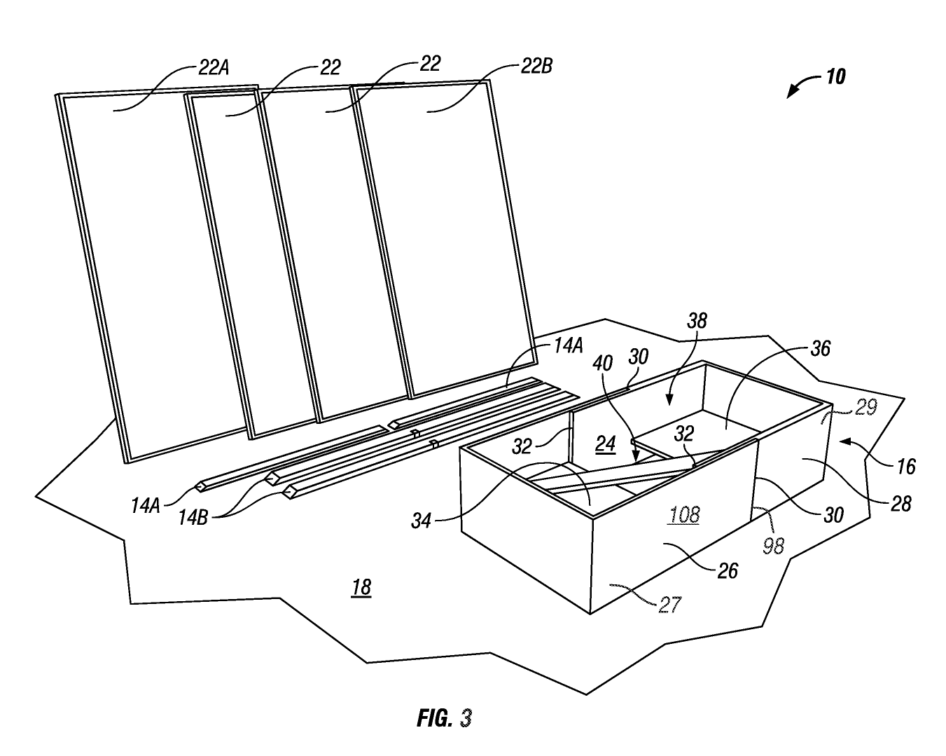

Referring to FIGS. 3 and 18, the components of the second configuration 250 are disassembled in order to convert the convertible table 10 to its first configuration 200. The base members 26 and 28 are positioned on their sides, from the substantially vertical orientation of the second configuration 250 to a substantially horizontal orientation, and coupled along their respective ends 30 and 32.

As shown in FIGS. 1, 3, 4, and 5, the ends 30 of the base member 28 have a length 104 encompassing a recess 102 along at least a portion of at least one wall 29. The width 106 of the remaining non-recessed portion of the wall 29 may be wider than the width 107 of the walls 27 of base member 26.

When coupled together, at least a portion of the wall 27 extends within the recessed area 102 of the wall 29. The end 32 of the base member 28 may extend farther within the interior space 24 than at least a portion of the walls 27. This configuration allows for a substantially flush surface 108 along the sides of the base 16 when the base member 26 substantially abuts the shoulder 98 of the recess 102. Alternatively, this configuration allows for adjustment of the length 110 of the side of the base 16 as needed by pulling the base member 26 away from the shoulder 98 of the recess 102 thus increasing the interior area 24 of the base 16.

When coupled, the inner members 34 and 36 may provide shelving space along the interior 24 of the base 16. In the exemplary embodiment, a portion of the ground 18 is visible through the interior space 24 of the base 16. This area may be closed off completely by extending the length of the inner members 34 and 36 if desired. The inner members 34 and 36 may be positioned proximate the ground 18 if a larger open interior area 24 is desired.

It should be apparent that the convertible table 10 may be disposed on various types of surfaces 18, whether the surface is indoors or outdoors, elevated or lower, tile, wood flooring, laminate, carpet, and so on.

Referring to FIG. 3, various objects 38, including but not limited to components of the convertible table such as the brace 40 and connection members 54; game equipment such as a net assembly 84, paddles, balls, etc.; video games; DVDs; game consoles; magazines; and other items that are sized such that they may fit within the interior area 24 of the base 16, may be stored within the base 16.

Referring to FIGS. 1, 3, and 15, the panels 22 are combined to produce a lesser surface area than the panel 22 orientation of the second configuration 250. The panels 22 of the exemplary embodiment are placed on top of the base 16 and are all stacked evenly. Alternative embodiments may provide for staggered stacking of the panels 22, or a varied orientation of the panels 22, such as allowing for more than one stack of panels 22 upon the base 16 and so forth, wherein the surface area of the first configuration 200 may be larger than the surface area of a single panel 22 yet be of a lesser surface area than the top 80 of the second configuration 250.

Panel 22B has a plurality of retainers 114 (see FIG. 1) affixed to the retainer surface 116. The retainers 114 are sized and spaced to allow for at least partial insertion within the interior area 24 of the base 16 to allow for functional engagement with the sidewalls 27 and 29 of the base 16 when needed in order to retain the panel 22B on the base 16. The retainers 114 may not be in direct contact with the interior wall surfaces 127 and 129 of the walls 27 and 29 at all times. Contact may only occur when the panel 22B is acted upon wherein it is moved toward a surface 127 and/or 129.

The use of the retainers, aids in preventing accidental movement of the panel 22B in relation to the base 16. The remaining panels 22, when secured to panel 22B in some manner such as with the support members 14, will be coupled to panel 22B such that panel 22B may likewise prevent unintended or accidental movement of the remaining panels 22 in relation to the base 16.

Panel 22A may have at least one finished surface 120 that is finished, such as by painting, staining, decorating, or the like. The finished surface 120 will form the viewable surface for the top 12 of the first configuration 200. In this example, the top surface 120 of the upper panel 22A is painted, e.g., painted the same as, or to coordinate with, the remaining viewable surfaces of the convertible table 10 in the first configuration 200.

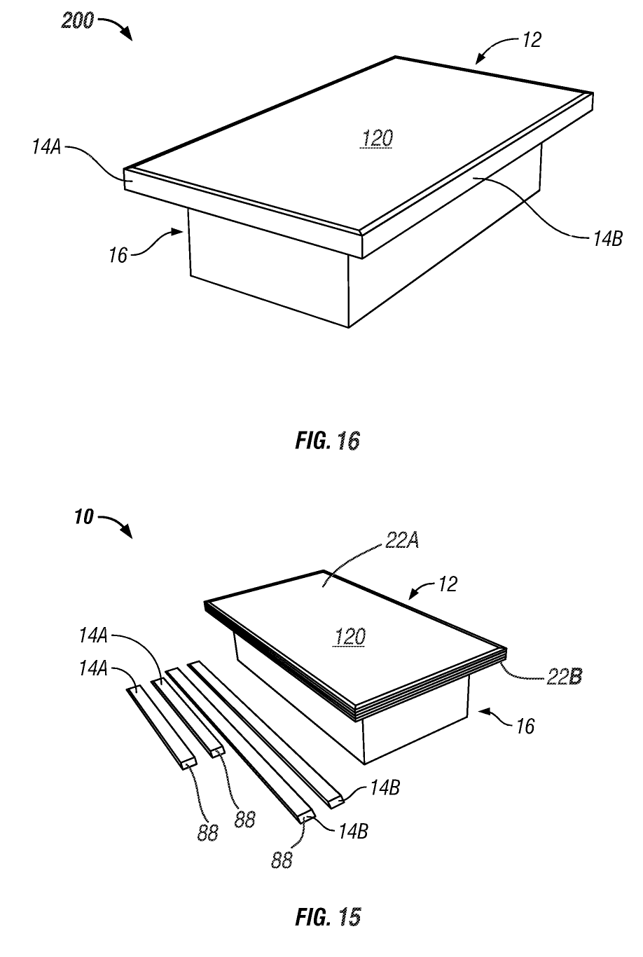

In the exemplary embodiment of FIG. 15, panel 22B is placed atop the base 16 first with the retainers 114 directed downward towards the interior area 24 of the base 16. The remaining panels 22 are placed on top of panel 22B with panel 22A placed at the very top with its finished side facing up away from the base 16 and completing top 12. The panels 22A, 22B, and 22 for the top 12.

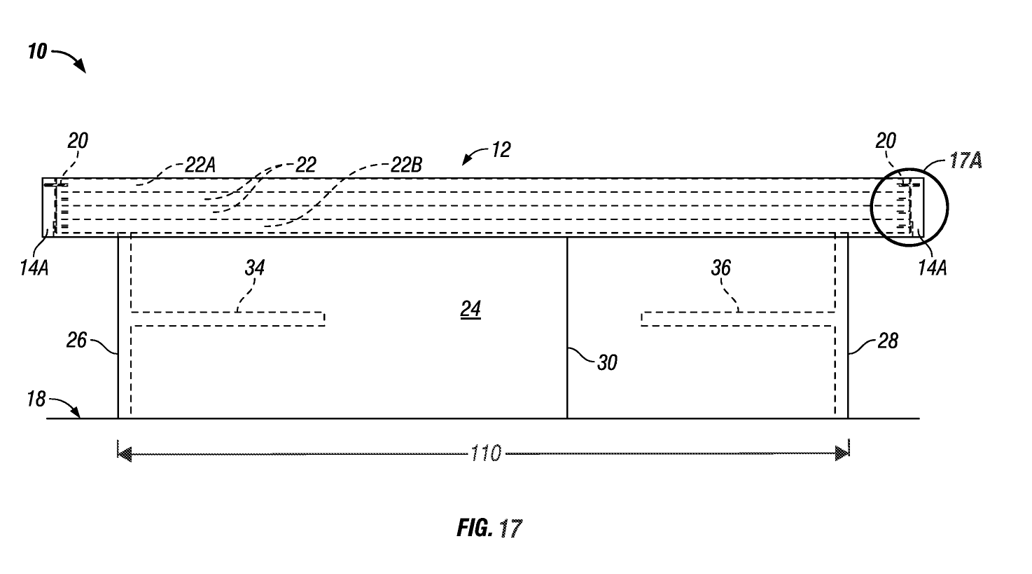

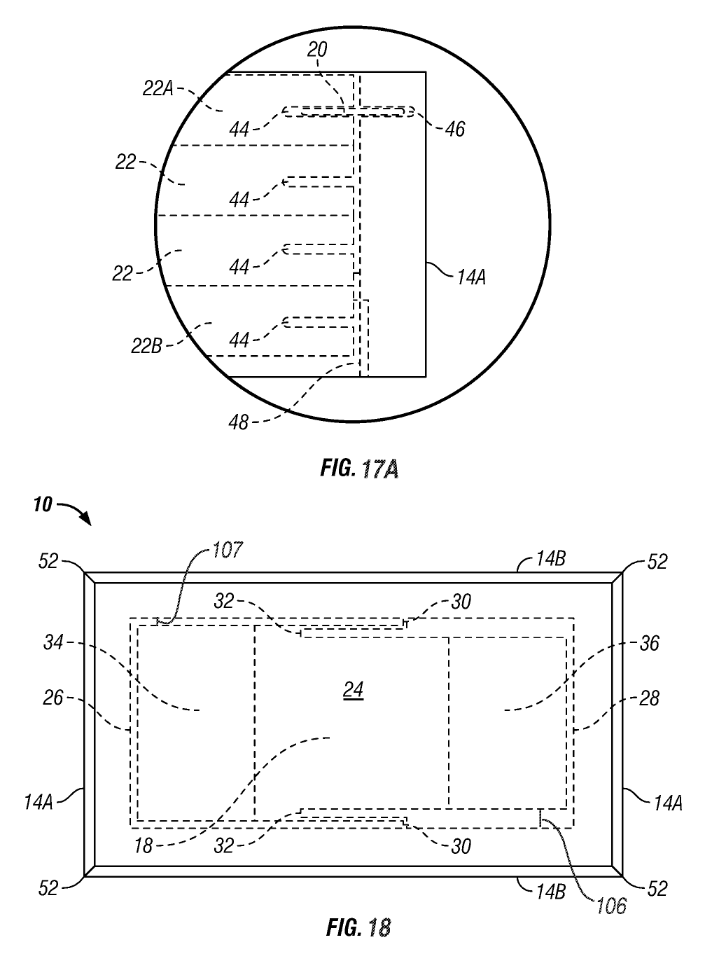

Referring to FIGS. 15, 17, and 17A, The support members 14 have at least one slot 46 extending along their inner surface 15 distal their indention 48. A purpose of the slot 46 is to allow coupling of the support members 14 to at least one panel 22 such that the support members 14 form a trim along the periphery of the panels 22. A purpose of the trim is to retain the panels 22 in an even configuration atop the base 16 and to cover the stacked nature of the panels 22 for alternative uses of the convertible table 10. Another purpose may be to couple the panels 22 to panel 22B so as to take advantage of the retainers 114 attached thereto. Therefore, the positioning of the slot 46 may vary so long as the slot 46 aligns with a slot 44 on the corresponding panel 22. Thus, the slot 46 may be positioned along any portion of the inside surface 15 of the support member 14 that coincides with a slot 44 on at least one of the adjacent panels sides 94 or 95.

FIG. 17 is a cross section of the table 10 of FIG. 16. The alignment of the slot 46 with a corresponding slot 44 is shown in more detail in FIG. 17A. The splines 20 are positioned around the periphery of the table 200 within at least a portion of the corresponding slots 44 and 46 in order to retain the support members 14 onto at least one panel 22. The splines 20 may be positioned to interact with the same panel 22, different panels 22, or variations of the two. The purpose of the splines 20 is to retain the support members 14 onto at least one panel 22; therefore, alternative connection assemblies that are known or hereafter discovered may be utilized to affect the same purpose.

Alternatively, the support members 14 may couple to the base 16 in order to form the trim.

Returning to FIGS. 15 and 16, the support members 14 of the exemplary embodiment have corresponding tapered ends 88 to facilitate their interface when in the first configuration 200. The purpose is to allow for a finished coupling of adjacent support members 14. This may be accomplished through other known or later discovered means.

In the exemplary embodiment, the shorter support members 14A are positioned along the lateral ends 94 of the stacked panels 22, and the longer support members 14B are positioned along the longitudinally extending ends 95 of the panels 22 such that the lengths of the support members 14 are substantially similar to, or slightly longer than, the lengths of the corresponding panel ends 94 or 95.

The sides of the support members 14 may be finished and/or configured to provide an aesthetic appearance in the first configuration 200.

Alternatively, the walls 27 and 29 of the respective base members 26 and 28 may be of equal width wherein the base member's ends 30 and 32 abut in the first configuration 200.

The first configuration table 200 may be used as a coffee table, children's table, end table, or in any other manner as appropriate. The second table 250 may provide use as a ping pong table, model building table, game table, card table, or any other use as appropriate.

The panels 22 may combine to form a regulation sized ping pong table as determined by the relevant regulatory entities. A net assembly 84 may be affixed to the top 80 for play, see FIGS. 1 and 2.

The various members and components described herein may typically be manufactured, obtained, or customized via known techniques. The panels 22, 22A, 22B may be constructed of wood, such as oak, pine, plywood, regular wood, and/or finished wood, for example. In alternative embodiments, the panels 22, 22A, 22B are plywood (e.g., 0.3175 cm (⅛″) to 2.54 cm (1″) thicknesses). A consideration in selecting the material for the panels 22, 22A, 22B may be to select a material to preclude significant warping of the panels 22, 22A, 22B. In addition, the material and size of the individual panel 22 may be chosen to provide ease of assembly of the table 10, so as to allow average individuals to manipulate the components of the table 10 in order to construct the first configuration 200 and/or the second configuration 250 as desired. In an alternative embodiment, the panels 22, 22A, 22B are 1.27 cm (½″) rough birch plywood. The birch wood may provide for resiliency in the second or larger configuration of the table 10 as a ping pong table or table tennis table, for example.

The slots 44 on the panels 22 may vary in width or thickness. In an alternative embodiment the slots are 0.3175 cm (⅛″) or less. In a further alternative embodiment, a power saw or table saw, for instance, is used to make a 0.3175 cm (⅛″) cut in the ends and sides of the panels 22, 22A, 22B. While the cuts or slots 44 may be offset, they are generally in the middle of the sides/ends of the panels 22, 22A, 22B to facilitate appropriate assembly of the second configuration 250 of the convertible table 10.

The splines 20 may be constructed of metal (e.g., carbon steel, stainless steel, etc.), wood, strong plastic, and so forth. In an alternative embodiment, the splines 20 are constructed of metal, such as stainless steel. In alternative embodiments, the thickness of the splines 20 may not be very controlled but will generally be less than 0.3175 cm (⅛″). On the other hand, the thickness of the splines 20 can be more controlled, such as with a more precision saw, planning device, milling device, and the like.

The base members 26 and 28, the support members 14, and the brace 40 may also be constructed of wood, such as oak, pine, plywood, and so forth. In alternative embodiments, the support members 14 and the brace 40 are constructed of a finished wood, such as oak, and may be constructed a shop like a cabinet shop, for example.

In an alternative embodiment, the base members 26 and 28 are veneer plywood having a finish on the outer surface, and a thickness in the range of 0.635 cm (¼″) to 2.54 cm (1″) (e.g., 1.905 cm (¾″)). In general, the base members 26 and 28 may be relatively thicker than the panels 22, 22A, 22B to provide for stability of the convertible table 10, for example. The overall width of the base members 26 and 28 from side to side may be selected such that the base 16 can adequately receive and support the panels 22, 22A, 22B. The inner members 34 and 36 of the base members 26 and 26, respectively, may provide for lateral stability.

Generally, FIGS. 2, 13, 12, 11, 5, 4, 3, 14, 15 and 16, in sequence, show a method of converting the table 10 from the second configuration 250 to the first configuration 200. The net assembly 84, if present, or any other item that have been placed on and/or attached to the table 10 is removed. The panels 22 are detached from the adjacent panels 22 and removed from the support base 100. The splines 20 are removed from any panels 22 that will not provide attachment to the support members 14 in the first configuration 200. The support members 14 are detached from their respective base members 26 and 28 and/or the brace 40. The brace 40 is detached from the base members 26 and 28.

The base members 26 and 28 are placed on their sides and slid together to form the base 16 of the first configuration 200. Objects 38 may be placed within the interior area 24 of the base 16. Panel 22B is located and placed on top of the base 16 with the retainers 114 positioned such that they will generally retain the panel 22B on top of the base 16 at least in relation to some lateral pressure. The remaining panels 22 are evenly stacked upon panel 22B. Panel 22A is the final panel to be placed on top of the base 16 with the finished side 120 up, if there is one, forming the top surface of the first configuration 200. The sides of the panels 22 are aligned to provide a substantially even outer periphery of the table 200. Spines 20 are inserted into the slots 46 and/or slots 44 as needed to couple the support members 14 to the panels 22. The support members 14 are arranged around the periphery of the table 200. Alternative connection devices may be utilized to perform the function of retaining the support members 14 to the table 200. The first configuration 200 is complete.

Generally, FIGS. 16, 15, 3, 4, 5, 11, 12, 13, and 2, in sequence, show a method of converting the table 10 from the first configuration 200 to the second configuration 250. The support members 14 are removed from the sides of the panels 22. The splines 20 may be removed from the support members 14 if still attached thereto. Some splines 20 may be removed from the panels 22 if needed. The panels 22 are removed from the base 16. The objects 38 are removed from the base 16. The base members 26 and 28 are separated and positioned in a vertical orientation some distance from each other. The brace 40 is placed in position between the base members 26 and 28 and the members 26 and 28 are spatially positioned in accordance with the brace 40. The support members 14 are positioned in relation to the base members 26 and 28 and the brace 40. The support members 14 are functionally connected to the base members 26 and 28. The support members 14 may be functionally connected to the brace 40. The brace 40 is functionally connected to the base members 26 and 28 and/or support members 14.

The panels 22 are positioned on the support base 100. The first panel 22 is positioned over at least a portion of the support members 14 attached to one of the base members 26 or 28. A spline 20 is attached to the panel 22 if not previously attached. The spline 20 is positioned so that a portion 21 extends beyond a lateral end 94 of the panel 22 proximate the brace 40. Alternatively, a spline 20 may not be utilized and a known or later discovered connector may be utilized to connect the panels 22.

A second panel 22 is positioned adjacent to the longitudinally extending side 95 of the panel 22 and functionally connected to the first panel 22. The panels are lined up so that they form a uniform half 90.

Another spline 20 is positioned within the slot 44 on the lateral end 94 of either the first or second installed panel 22, unless already in position. A third panel 22 is connected to either the first or second installed panel 22 at their respective lateral ends 94. At least one other spline 20 may be attached within the slot 44 along the lateral end 94 and/or the longitudinally extending end 95 of the fourth panel, or the panel 22 that will be functionally coupled with the fourth panel 22. The fourth panel 22 is installed adjacent to the third installed panel 22 and the open side of the first or second installed panel 22. The expanded table 250 may have items added to it for play, such as the net assembly 84 or other items as needed.

Alternatively the initial panels 22 may be connected along their lateral ends 94 rather than along their longitudinally extending ends 95. The assembly would then continue with attachment of the splines 20 and remaining panels 22 to the longitudinally extending ends 95 of the already installed panels 22.

A method of using a convertible table comprising a disassembling step, a converting step and an assembling step. The disassembling step comprises disassembling components of a configuration wherein the components include a top. The top comprises a plurality of panels and a base. The converting step comprises converting the base to support the top in the desired configuration. The assembling step comprises assembling the top upon the base.

The disassembling step of the method may include any of the following in any combination and order: removing a plurality of support members from the outer periphery of the top; unstacking the plurality of panels, and pulling apart at least two base members that form the base; disassembling a second configuration including uncoupling the plurality of panels from each other, and removing a plurality of support members from the base.

The converting step of the method may include any of the following in any combination and order: converting the base of a first configuration to the base of a second configuration including moving at least two base members of the base into substantially vertical orientations from the substantially horizontal orientation of the first configuration, coupling at least two of the base members to each other with a brace, and functionally coupling at least one support member to at least one base; converting the base of a second configuration to the base of a first configuration including moving at least two base members of the base into substantially horizontal orientations from the substantially vertical orientation of the first configuration, and coupling the base members together. The coupling step may further include coupling at least one wall of a first base member to at least one wall of a second base member wherein the at least one wall of the second base member contains a recessed area along one end of the wall, and wherein the at least one wall of the first base member is at least partially inserted within the recess.

The assembling step of the method may include stacking the plurality of panels on top of each other and arranging a plurality of support members around the periphery of the stacked panels. The step may further include coupling the plurality of support members to the periphery of the stacked panels with at least one spline. The assembling step may include arranging at least two of the plurality of panels in a planar relationship on top of the base. The step may further include connecting at least two panels together with at least one spline.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features and characteristics described in conjunction with a particular aspect, embodiment or example of the invention are to be understood to be applicable to any other aspect, embodiment or example described herein unless incompatible therewith.

All of the features disclosed in this specification (including any accompanying claims, abstract and drawings), and/or all of the steps of any method or process so disclosed, may be combined in any combination, except combinations where at least some of such features and/or steps are mutually exclusive. It is not necessary that the method steps disclosed be performed in any particular order, not even the order in which the steps are disclosed herein. The steps may be performed in any logical order. For example only, the spines 20 may be positioned along the panels 22 directly after the panels are removed from the base 16, may be applied while the panels 22 are still on the base 16, may be applied as the panels 22 are being installed on the support base 100, and/or may be applied in any combination of the foregoing.

Each feature disclosed in this specification (including any accompanying claims, abstract and drawings), may be replaced by alternative features serving the same, equivalent, or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

I claim:

1. A table convertible between a first configuration and a second configuration, the table comprising:
a top comprising a plurality of panels, wherein the panels are configured in an alternative orientation in the first configuration in relation to the second configuration;
a base configured to support the top in both the first configuration and the second configuration; and
a plurality of support members configured to couple to at least a portion of the outer periphery of the top in the first configuration and configured to functionally couple to the base in the second configuration.

2. The table of claim 1, wherein the plurality of panels that form the top in the second configuration are connected to each other by at least one connection member connecting adjacent tables along their respective sides.

3. The table of claim 2, wherein:
each of the plurality of panels that form the top in the second configuration have at least one slot disposed within at least a portion of an edge of the panels; and
wherein the at least one connection member is at least one spline configured to couple at least two panels through at least one pair of corresponding slots contained therebetween.

4. The table of claim 3, wherein the at least one slot disposed within at least a portion of the edge of the panels is disposed within at least a portion of each edge of each panel.

5. The table of claim 1, wherein:
the top is comprised of two halves, wherein the first half is comprised of two panels coupled along corresponding longitudinally extending edges, and the second half is comprised of two additional panels coupled along corresponding longitudinally extending sides;
wherein the two halves are coupled to each other along their corresponding lateral ends forming a four paneled top; and
wherein a spline extended portion at least partially couples all of the four panels at their commonly shared corner.

6. The table of claim 1, wherein:
the panels are coupled by a plurality of splines in the second configuration; and
at least one spline extended portion partially couples at least three of the panels at a common corner shared between the panels.

7. The table of claim 1, wherein:
the base of the second configuration is a support base having two base members, wherein the base members are functionally coupled by at least one brace disposed therebetween; and
at least one of the plurality of support members is functionally coupled to one of the base members.

8. The table of claim 7, wherein one connection member simultaneously couples the brace, at least one of the plurality of support members, and one of the base members.

9. The table of claim 1, wherein the top in the second configuration has a larger surface area than the top in the first configuration; and wherein the base in the second configuration is of a greater height than the base in the first configuration.

10. The table of claim 1, wherein:
the base having two base members;
each of the base members having at least two walls, wherein at least two of the walls are opposing walls;
each of the opposing walls having at least two ends; and
at least one of the opposing walls, of one of the base members, having a recess disposed proximate one of the ends.

11. The table of claim 10, further comprising:
each of the base members having a cavity interior to the at least two opposing walls of the respective base members; and
an inner member disposed within the cavity, intermediate the at least two opposing walls.

12. The table of claim 10, wherein the two base members coupled in the first configuration with at least one of the ends of the first base member configured to fit at least partially within the recess on the second base member.

13. The table of claim 12, wherein the outer surface of the non-recessed portion of the wall containing the recess on the second base member and the outer surface of the coupling wall on the first base member are substantially planar when the base members are coupled in the first configuration.

14. The table of claim 13, wherein:
at least one of the walls of the second base member having a shoulder, the shoulder is defined by the border between the recessed and the non-recessed portions of the wall; and
wherein the end of the coupling wall of the first base member is disposed proximate the shoulder of the second base member in the first configuration.

15. The table of claim 1, wherein the perimeter of the base defines an internal cavity when the base is arranged in the first configuration.

16. The table of claim 1, wherein the plurality of support members that form a trim for the top when the table is in the first configuration are connected to at least one of the panels by at least one connection member.

17. The table of claim 16, wherein:
each of the plurality of support members that form the trim for the top when the table is in the first configuration have at least one slot disposed along at least a portion of each of the support members;
at least one of said plurality of panels having at least one corresponding slot along an edge of the panel; and
wherein the at least one connection member is at least one spline configured to couple at least one of said plurality of panels to at least one of said plurality of support members through at least one pair of corresponding slots contained therebetween.

18. The table of claim 1 wherein:
the plurality of panels are stacked in the first configuration;
at least one of the panels having a retainer surface, wherein a plurality of retainers is disposed on the retainer surface;
the retainer surface of the at least one panel disposed directly on top of the base with the retainers disposed at least partially within the base;
at least one of the panels having a finished surface; and
the panel with the finished surface is placed on top of the stacked panels with the finished surface visible as the surface of the top.

19. A table convertible between a smaller configuration and a larger configuration, the table comprising:
a top comprising a plurality of panels;
the plurality of panels stacked in the smaller configuration and substantially planar in the larger configuration;
each of the panels having at least one slot disposed within each edge of each panel;
at least two base members configured to support the top in both the smaller configuration and the larger configuration;
a plurality of support members;
each of the plurality of support members that will form a trim of the top in the smaller configuration having at least one slot disposed along at least one side;
at least one of the plurality of support members coupled to at least one base member by at least one connection member in the larger configuration;
the plurality of support members coupled to the periphery of at least one of the panels by at least one spline disposed along adjacent slots in both the panels and the support members in the smaller configuration;
a brace functionally coupling at least two of the base members;
a plurality of retainers contained on a retainer surface of one of the panels;
the retainers disposed within at least a portion of the base;
one of the panels having at least one finished surface; and
the panel with the finished surface being on top of the stack of panels in the smaller configuration with the finished surface facing away from the base.

20. A method comprising:
a disassembling step comprising disassembling components of a configuration wherein the components include a top comprising a plurality of panels and a base;
a converting step comprising converting the base to support the top in the desired configuration;
an assembling step comprising assembling the top upon the base;

21. The method of claim 20, wherein the disassembling step of disassembling a first configuration includes removing a plurality of support members from the outer periphery of the top.

22. The method of claim 21, wherein the disassembling step includes unstacking the plurality of panels, and pulling apart at least two base members that form the base.

23. The method of claim 20, wherein the disassembling step of disassembling a second configuration includes uncoupling the plurality of panels from each other, and removing a plurality of support members from the base.

24. The method of claim 20, wherein the converting step of converting the base of a first configuration to the base of a second configuration includes moving at least two base members of the base into substantially vertical orientations from the substantially horizontal orientation of the first configuration; coupling at least two of the base members to each other with a brace; and functionally coupling at least one support member to at least one base.

25. The method of claim 20, wherein the converting step of converting the base of a second configuration to the base of a first configuration includes moving at least two base members of the base into substantially horizontal orientations from the substantially vertical orientation of the first configuration; and coupling the base members together.

26. The method of claim 25, wherein the coupling of the base members of the converting step includes coupling at least one wall of a first base member to at least one wall of a second base member wherein the at least one wall of the second base member contains a recessed area along one end of the wall, and wherein the at least one wall of the first base member is at least partially inserted within the recess.

27. The method of claim 20, wherein the assembling step of the first configuration includes stacking the plurality of panels on top of each other and arranging a plurality of support members around the periphery of the stacked panels.

28. The method of claim 27, wherein the assembling step includes coupling the plurality of support members to the periphery of the stacked panels with at least one spline.

29. The method of claim 20, wherein the assembling step of the second configuration includes arranging at least two of the plurality of panels in a planar relationship on top of the base.

30. The method of claim 29, wherein the assembling step includes connecting at least two panels together with at least one spline.
